(19) United States
(12) Patent Application Publication
(10) Pub. No.: US 2005/0165737 A1
(43) Pub. Date: Jul. 28, 2005

(54) Information processing apparatus

(76) Inventor: Yasuyuki Tomida, Ibaraki-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/508,153

(22) PCT Filed: Mar. 18, 2003
(86) PCT No.: PCT/JP03/03222

(30) Foreign Application Priority Data
Mar. 18, 2002 (JP) 2002-73603

(51) Int. Cl. G06F 7/00

(52) U.S. Cl. 707/3

(57) ABSTRACT

Provided is an information processing apparatus which can perform memory accesses from plural processing sections without breaking the memory accesses.

The information processing apparatus (101) is provided with the pre-stage processing section (3) which arbitrates among plural access requests with respect to the integrated memory (5) in the access request control circuit (22) and issues a predetermined number of access requests, the post-stage processing section (4) which issues plural access requests with respect to the integrated memory (5), and the integrated memory control circuit (18) which arbitrates among access requests from the pre-stage processing section (3) and the post-stage processing section (4), and outputs any of the access requests to the integrated memory (5), wherein the access request control circuit (22) and the integrated memory control circuit (18) are adapted to perform arbitration on the basis of the perioridicity of the respective access factors and the regularity of the access destination addresses.

### TECHNICAL FIELD

The present invention relates to an information processing apparatus, and, more particularly, to an information processing apparatus which can perform memory accesses to one storage unit from plural processing sections without breaking the memory accesses.

### BACKGROUND ART

Conventionally, as an information processing apparatus for accessing a media in which data are accumulated, an information processing apparatus comprising a pre-stage processing section which performs access to the media such as reading and writing and a post-stage processing section which decodes and encodes data handled by the pre-stage processing section and the like, is employed.

Hereinafter, a prior art information processing apparatus comprising the pre-stage processing section and the post-stage processing section will be described with reference to the drawings. FIG. 6 is a block diagram illustrating a configuration of the prior art information processing apparatus 104.

The information processing apparatus 104 processes data accumulated in the media 2, and comprises a pre-stage processing section 3 for accessing the media 2, a post-stage processing section 4 for performing processing of data which are read from the media 2 by the pre-stage processing section 3 and creating data to be written into the media 2 by the pre-stage processing section 3, a first memory 5a which can be accessed by the pre-stage processing section 3, and a second memory 5b which can be accessed by the post-stage processing section 4. The pre-stage processing section 3, the post-stage processing section 4, the first memory 5a, and the second memory 5b are semiconductor integrated circuits, respectively, which are different from each other.

The pre-stage processing section 3 is connected to the media 2 through a data signal 6a and a data signal 6b, and has functions of either/both reading data from the media 2 or/and writing data into the media 2. In order to realize the functions, the pre-stage processing section 3 includes a requester group 401 as factors for generating plural access requests with respect to the first memory 5a, and the requester group 401 issues plural access requests through request signals 402 which are provided by the same number as the number of access requests. Further, the pre-stage processing section 3 includes a memory control circuit 18a which arbitrates among plural access requests from the requester group 401 to output one of the access requests to the first memory 5a. The memory control circuit 18a is connected to the requester group 401 through request signals 402 and a data signal 403 and to the first memory 5a through a data signal 16.

The post-stage processing section 4 is connected to the pre-stage processing section 3 through a data signal 11a and a data signal 11b, and has functions of either/both performing processing of data which are read from the media 2 by the pre-stage processing section 3 or/and creating data to be written into the media 2 by the pre-stage processing section 3. Further, the post-stage processing section 4 includes a requester group 9 as factors for generating plural access requests with respect to the second memory 5b, and the requester group 9 issues plural access requests through request signals 13a which are provided by the same number as the number of access requests. Further, the post-stage processing section 4 includes a memory control circuit 18b which arbitrates among plural access requests from the requester group 9 to output one of the access requests to the second memory 5b. The memory control circuit 18b is connected to the requester group 9 through request signals 13a and a data signal 15a and to the second memory 5b through a data signal 17.

Here, the pre-stage processing section 3 performs media access such as reading and writing, while the post-stage processing section 4 performs complicated processing such as decoding and encoding signals. Therefore, the post-stage processing section 4 performs more stages of processing than the pre-stage processing section 3. In order to maintain data transfer rates equally between the pre-stage processing section 3 and the post-stage processing section 4, the first memory 5a may be a low-speed DRAM (Dynamic Random Access Memory) and the second memory 5b may be an SDRAM (Synchronous Dynamic Random Access Memory) which can perform higher-speed processing than the first memory 5a.

Next, an operation of the information processing apparatus 104 constructed as above will be described. Here, a case where the information processing apparatus 104 is an apparatus which reads compressed data of video and audio which are recorded in a digital versatile disk (hereinafter, referred to as a DVD), and outputs a video signal and an audio signal, wherein the pre-stage processing section 3 reads the compressed data from the DVD and the post-stage processing section 4 restores the compressed data, will be taken as an example.

In a case where the information processing apparatus 104 is an apparatus which reads data recorded in the DVD and outputs a video signal and an audio signal, the requester group 401 comprises the following access factors. That is, they are an access request from a central processing unit (not shown) which controls the information processing apparatus 104 (hereinafter, referred to as a CPU request), a write access request for demodulating data read from the media 2 and writing the demodulated data into the first memory 5a (hereinafter, referred to as a demodu-request), a read request for performing error correction of data which have been written by the demodu-request (hereinafter, referred to as an ECC read request), a correction request for error data found in the error correction (hereinafter, referred to as an ECC correction request), a read request for checking whether an error is left on the error-corrected data or not (hereinafter, referred to as an EDC request), a read request for outputting data which is confirmed as having no error to the data signal 11a (hereinafter, referred to as a HOST transfer request). The first memory 5a to be accessed is a DRAM, and therefore each of these access factors is of one word length.

The respective access factors will be described in detail.

The CPU request is an access which influences control of the pre-stage processing section 3 and the whole information processing apparatus 104, and it is an access request of greater importance. Further, an access destination addresses are generated at random.

The access requests other than the CPU request are based on data structure which is used at the error correction of DVD. An example of the data structure which is used at the error correction of DVD is shown in FIG. 7. In FIG. 7, D1 is a data area into which main data to be transmitted to the post-stage processing section 4 are stored, and C1 to C3 are redundant areas used for the error correction, respectively. The data area D1 has a capacity of e word length×g lines, and an address pd is given at the head thereof. Further, the redundant area C1 has a capacity of f word length×g lines and an address p1 is given at the head thereof, the redundant area C2 has a capacity of e word length×h lines and an address p2 is given at the head thereof, and the redundant area C3 has a capacity of f word length×h lines and an address p3 is given at the head thereof.

The demodu-request is a transfer request for developing data read from the media 2 into data structure shown in FIG. 7 and writing the data on the memory. For the demodu-request, accessing is performed as shown in FIG. 8, and the access destination addresses consecutively change to such as pd, pd+1, pd+2, . . . . Further, since data are read from the media 2 at low speed, once an access request is generated, a given time interval occurs until the subsequent access request is generated. However, when waiting time which exceeds this given time interval is generated before the demodu-request is accepted, some data which are read from the media 2 remain unprocessed, and thereby it is necessary that the waiting time should be short.

The ECC read request requires that the data on the first memory 5a be read so as to perform the error correction of the demodulated data. As a method for reading data, there are two kinds of methods, i.e., an external code reading and an internal code reading. In the external code reading, the access destination addresses change as shown in FIG. 9. That is, a request for reading data of addresses pd, pd+n, pd+2n (n is a natural number), pd+3n is generated. For the ECC read request of the external code reading, a subsequent access request is generated immediately after a request is accomplished until the completion of reading one vertical line. On the other hand, in the internal code reading, data are read in order similar to that for the demodu-request. Further, as in the external code reading, a subsequent access request is generated immediately after a request is accomplished until the completion of reading one horizontal line. For this ECC read request, a subsequent request is generated immediately after a request is accomplished until completing a given process unit, and therefore intensive execution is possible and there is resistance to waiting time.

In a case where an error is found in the data on the memory by an arithmetic (error correction) using data read by the ECC read request, an ECC correction request is issued. The access destination addresses for the ECC correction request are generated at random, and an access of a maximum of 16 bytes per one vertical line occurs in the correction of the external code reading, and an access of a maximum of 10 bytes per one horizontal line occurs in the correction of the internal code reading. The access requests are repetitions of 1 byte reading and 1 byte writing. For the ECC correction request, once access requests are continuously issued by the number of errors which can be corrected, an access request is not issued until the completion of reading one vertical line for a subsequent ECC read request.

Both the EDC request and the HOST transfer request are requests for reading only data area D1. That is, the EDC request is one which requires that data be read so as to check whether an error is left on the error-corrected data, while the HOST transfer request is one which requires that data which is confirmed as having no error be read and outputted to the post-stage processing section 4 through the data signal 11a. The access destination addresses for these access requests consecutively change to such as pd, pd+1, pd+2 . . . . Further, a subsequent access request is generated immediately after a request is accomplished until the whole data on the data area D1 are read. For the EDC request and HOST transfer request, a subsequent request is generated immediately after a request is accomplished until completing a given process unit, and therefore intensive execution is possible and there is resistance to waiting time.

The priority arbitrated by the memory control circuit 18a for the access requests issued by these access factors will be described.

In the pre-stage processing section 3, when an access to the first memory is generated in the process of reading data from the media 2 and writing data into the media 2, the requester group 401 issues an access request and the memory control circuit 18a outputs the access request to the first memory 5a. In a case where plural access requests are issued from the requester group 401, the memory control circuit 18a outputs one of the access requests to the first memory 5a on the basis of the priorities which are set according to the access factors.

In the post-stage processing section 4, when an access to the second memory 5b is generated in the process of processing data supplied from the pre-stage processing section 3 and creating data to be written into the media 2, the requester group 9 issues an request for accessing the second memory 5b, to the memory control circuit 18b. Since the second memory 5b is an SDRAM, the requester group 9 issues a transfer request of consecutive longer transfer length such as 32 word length and 64 word length.

An operation of the post-stage processing section 4 whose requester group 9 has three access factors of access factor A, access factor B, and access factor C in descending order of priority will be described with reference to FIG. 10. FIG. 10 shows access states for access factors A to C with assuming N=10 as a value of a natural number N which is used in the following description. In FIG. 10, a location where “req” is described designates a time at which an access request is issued, an area where “access” is described designates a time period during which data transfer is being performed, and an area where “wait” is described designates a waiting time.

For the access factor A, an access request for occupying the second memory 5b during 20N (N is a natural number) cycles inclusive of overhead for each access and an access request for occupying the second memory 5b during 10N cycles inclusive of overhead for each access are alternately issued twice, and when four access requests are accomplished, a suspension period of 200N cycles is entered. 8N cycles are required from the accomplishment of an access request to the issuance of the subsequent access request. Further, for each of the access factor B and access factor C, an access request for occupying the second memory 5b during 20N cycles inclusive of overhead for each access is issued. For the access factor B, a new access request is issued after 20N cycles from the accomplishment of an access request, and for the access factor C, a new access request is issued after 30N cycles from the accomplishment of an access request. These access factors are accomplished without generating long waiting time.

However, on a request of reduction in system cost and reduction in footprint, it is desired that the above-described pre-stage processing section 3 and the post-stage processing section 4 be formed in a single integrated circuit and the memories which are individually included in the pre-stage processing section 3 and the post-stage processing section 4 be integrated into one shared memory.

FIG. 11 shows a configuration of an information processing apparatus 105 in which the pre-stage processing section 3 and the post-stage processing section 4 are formed in a single integrated circuit and the first memory 5a and the second memory 5b are integrated into an integrated memory 5. In FIG. 11, the same reference numerals as those shown in FIG. 1 denote the same or corresponding portions, and a detailed description will be omitted.

The integrated memory 5 may be an SDRAM like the second memory 5b so as not to reduce the processing speed of the post-stage processing section 4. The integrated memory control circuit 18 is obtained by adding one channel for accepting an access request to the memory control circuit 18b included in the post-stage processing section 4 in the information processing apparatus 104, and a request signal 20 is connected to the added channel so that an access request issued from the memory control circuit 18a is input to the added channel. Further, the integrated memory control circuit 18 is connected to the memory control circuit 18a through a data signal 21.

In the information processing apparatus 105 so constructed, when an access to the integrated memory 5 is generated, the pre-stage processing section 3 issues access requests from the requester group 401, and the memory control circuit 18a outputs one of the access requests to the integrated memory control circuit 18 on the basis of the priorities which are set according to the access factors. On the other hand, when an access to the integrated memory 5 is generated, the post-stage processing section 4 issues requests for accessing the integrated memory 5 from the requester group 9 to the integrated memory control circuit 18. The integrated memory 5 arbitrates among the access request from the memory control circuit 18a and the access requests from the requester group 9, and performs the request for accessing the integrated memory 5.

As described above, in the information processing apparatus 105, the memory integration can be accomplished only by adding one channel for accepting an access request, to the memory control circuit 18b of the information processing apparatus 104.

On the other hand, the following discussion is provided from a point of view of a bandwidth. In a case where the integrated memory 5 is a generally used SDRAM of 16 bit width, and the post-stage processing section 4 operates this SDRAM at approximately 120 MHz, and the bandwidth of approximately 171 MB per second, which correspond to approximately 75% of the whole bandwidth at worst inclusive of overhead due to page miss, is occupied, the memory accesses for the following quantities are required for the access factors from the requester group 401, respectively, so that the pre-stage processing section 3 can perform DVD reading corresponding to double speed. 3.1 MB per second is required for the demodu-request from the requester group 401, approximately 9.3 MB per second is required for the ECC read request when the number of times of error correction is three, approximately 0.6 MB per second is required for the error correction request, approximately 2.7 MB per second is required for the EDC request, and approximately 2.7 bytes per second is required for the HOST transfer request. Therefore, the memory access should be accomplished at a rate of approximately 18.6 MB per second.

However, the memory control circuit 18b issues an access request in units of 1 to 4 bytes, and therefore there is a possibility that overhead due to page miss occurs extremely frequently. Considering the occupied bandwidth for the post-stage processing section 4, the occupied bandwidth for the pre-stage processing section 3 should be restricted to approximately 57 MB per second. However, under the worst condition that the pre-stage processing section 3 always accesses the integrated memory 5 in units of one word length, and overhead due to page miss occurs every time, the occupied bandwidth for the pre-stage processing section 3 exceeds 57 MB per second, thereby breaking the bandwidth. A portion of the access requests generated by the access factors from the requester group 401 should be converted into the access requests of approximately 30 to 40 word length so as to suppress the increase in page miss/overhead due to these access requests of shorter word lengths being overissued.

Further, while the requester group 9 in the post-stage processing section 4 issues the access requests of 32 word length and 64 word length as described above, the CPU request and demodu-request issued by the requester group 401 have greater importance and do not have room for waiting time. Therefore, in a case where the CPU request and demodu-request are caused to wait by the access requests generated by plural access factors from the requester group 9, there is a possibility that the memory access can not be completed within a required time period. Therefore, the request signals 402 require a higher priority than all the access requests from the requester group 9 in the access arbitration by the integrated memory control circuit 18. With this, however, the access requests such as the EDC request and HOST transfer request are accepted at the higher priority. For these access factors, access requests are continuously issued until a given unit of processing is completed as described above, and therefore when these access requests are given the higher priority, the accesses from the requester group 9 are prevented, thereby substantially delaying the processing.

Here, the access states for the HOST transfer request, the EDC request, the ECC read request and the access factors A to C for a case where the post-stage processing section 4 in the information processing apparatus 105 has, as access factors, access factors A to C which are similar to those of the information processing apparatus 104, will be described with reference to FIG. 12. FIG. 12 is a diagram illustrating the access states for the HOST transfer request, the EDC request, the ECC read request, and the access factors A to C.

It is necessary that the access requests generated by the access factors from the requester group 401 should be converted into access requests of longer word lengths so as to suppress increase in page miss/overhead due to the access requests of shorter word lengths being overissued. Hereinafter, an access request obtained by converting an EDC request into an access request of longer word length is referred to as a converted EDC request, an access request obtained by converting a HOST transfer request into an access request of longer word length is referred to as a converted HOST transfer request, and an access request obtained by converting an ECC read request into an access request of longer word length is referred to as a converted ECC read request.

For each of the converted EDC request and the converted HOST request, an access request for occupying the SDRAM during 8N cycles inclusive of overhead is issued. For the converted ECC read request, an access request for occupying the SDRAM during 10N cycles is continuously issued and a suspension period of 200N cycles is entered. For the converted EDC request, 20N cycles are required from the accomplishment of a request until a subsequent converted EDC access request can be issued. For the converted HOST transfer request, 24N cycles are required from the accomplishment of a request until a subsequent converted HOST transfer request can be issued. Further, the memory control circuit 18a arbitrates among plural access requests of the pre-stage processing section 3 to output an access request to the integrated memory control circuit 18. In such a memory access state, as shown in FIG. 12, the access factor C of the post-stage processing section 4 is forced to have an abnormally longer waiting time, thereby breaking micro memory access and completely delaying the accesses.

The present invention is made to solve the above-mentioned problems and its object is to provide an information processing apparatus which suppresses overissue of the access requests of shorter word lengths and can perform memory accesses from plural processing sections without breaking bandwidth due to overhead caused by page miss.

### DISCLOSURE OF THE INVENTION

In order to solve the above-mentioned problems, an information processing apparatus according to claim 1 of the present invention comprises: a storage unit for storing data; a first data processing section for issuing plural access requests and accessing the storage unit; a second data processing section for issuing access requests and accessing the storage unit; an access request controller for arbitrating among the plural access requests of the first data processing section to output a predetermined number of access requests; and an access arbitration unit for arbitrating among the access requests from the access request controller and the access requests from the second data processing section.

According to claim 2 of the present invention, there is provided the information processing apparatus as defined in claim 1 wherein the access request controller comprises an arbitration unit which adds a higher priority or a lower priority than a priority for the access requests of the second data processing section, to the access requests from the first data processing section to issue the access requests.

According to claim 3 of the present invention, there is provided the information processing apparatus as defined in claim 2 wherein the first data processing section comprises: a first access request generation unit for generating access requests of a higher priority; and a second access request generation unit for generating access requests having a lower priority and consecutiveness in the access destination address, wherein the arbitration unit issues the access requests from the first access request generation unit at the highest priority and issues the access requests from the second access request generation unit at a priority lower than that of the access requests from the second data processing section.

According to claim 4 of the present invention, there is provided the information processing apparatus as defined in claim 2, wherein the access request controller comprises a buffer for accumulating data, and when an access request from the first data processing section is a write request with respect to the storage unit, the arbitration unit judges whether the arbitration unit issues an access request for writing a data amount which is requested by the write request, or accumulates a specified amount of data to be written, in the buffer, and thereafter converts the request into an access request for intensively writing the accumulated data to issue the converted access request.

According to claim 5 of the present invention, there is provided the information processing apparatus as defined in claim 2 wherein the access request controller comprises a buffer for accumulating data, and when an access request from the first data processing section is a read request with respect to the storage unit, the arbitration unit judges whether the arbitration unit issues an access request for reading data of an amount requested by the read request, or converts the request into an access request for intensively and previously reading more data than the requested amount by a specified amount and accumulating the read data in the buffer to issue the converted access request, or reads the data accumulated in the buffer without issuing an access request.

According to claim 6 of the present invention, there is provided the information processing apparatus as defined in claim 2 wherein when an access request from the first data processing section is periodically generated at regular time intervals, the arbitration unit issues the access request at a priority higher than that of access requests from the second data processing section, and when an access request from the first data processing section is continuously generated with no time interval after an access request is accomplished, the arbitration unit issues the access request at a priority lower than that of access requests from the second data processing section.

According to claim 7 of the present invention, there is provided the information processing apparatus as defined in any of claims 1 to 6 wherein the first data processing section comprises: a demodulating and writing means for demodulating data recorded in a storage medium which can be accessed by the first data processing section and writing the demodulated data into the storage unit; an error correction means for reading data written in the storage unit and writing error-corrected data obtained by error-correcting the read data into the storage unit; an error detection means for reading the data which have been error-corrected from the storage unit and checking the data for error; and a reading means for reading data which is confirmed as having no error by the error detection means, from the storage unit, and outputting the read data to the second data processing section, and when an access request from the first data processing section is generated by the demodulating and writing means, the arbitration unit sets a priority for an access request to be issued to the access arbitration unit to be higher than a priority for access requests from the second data processing section, and when an access request from the first data processing section is generated by any of the error correction means, the error detection means, and the reading means, the arbitration unit sets a priority for an access request to be issued to the access arbitration unit to be lower than a priority for access requests from the second data processing section.

According to claim 8 of the present invention, there is provided the information processing apparatus as defined in claim 1 wherein the second data processing section or the access arbitration unit comprises an access frequency detection unit for detecting a time period during which occurrence frequency of access to the storage unit from the second data processing section is low, and notifying the access request controller of the time period, and the access request controller suppresses issuance of access requests except in the time period and promotes issuance of access requests in the time period on the basis of the notification from the access frequency detection unit.

According to claim 9 of the present invention, there is provided the information processing apparatus as defined in claim 1 wherein the first data processing section comprises: an error correction means for reading data written in the storage unit and writing error-corrected data obtained by error-correcting the read data into the storage unit; and a reading means for reading data which is confirmed as having no error by the error detection means, from the storage unit, and outputting the read data to the second data processing section, and the second data processing section or the access arbitration unit comprises an access frequency detection unit for detecting a start and an end of a time period during which occurrence frequency of access to the storage unit from the second data processing section is low, and notifying the access request controller of the start and the end, and the first data processing section operates the error correction means and the reading means when the start of the time period is detected by the access frequency detection unit, and the first data processing section delays or stops the operations of the error correction means and the reading means when the end of the time period is detected.

As described above, an information processing apparatus according to claim 1 of the present invention comprises: a storage unit for storing data; a first data processing section for issuing plural access requests and accessing the storage unit; a second data processing section for issuing access requests and accessing the storage unit; an access request controller for arbitrating among the plural access requests of the first data processing section to output a predetermined number of access requests; and an access arbitration unit for arbitrating among the access requests from the access request controller and the access requests from the second data processing section. Therefore, even when the processing speed of the first data processing section is low and the second data processing section requires high-speed processing, the first and the second processing sections can share the storage unit without breaking memory accesses. With this, a low-speed storage unit which is conventionally required so as to be accessed by the first data processing section is dispensed with, and further the first data processing section and the second data processing section can be formed in a single semiconductor integrated circuit, thereby reducing the number of components and a footprint of the information processing apparatus and reducing production cost.

According to claim 2 of the present invention, there is provided the information processing apparatus as defined in claim 1 wherein the access request controller comprises an arbitration unit which adds a higher priority or a lower priority than a priority for the access requests of the second data processing section, to the access requests from the first data processing section to issue the access requests. Therefore, an arbitration is performed on the basis of the priorities of the respective access requests, thereby avoiding breakage of memory accesses.

According to claim 3 of the present invention, there is provided the information processing apparatus as defined in claim 2 wherein the first data processing section comprises: a first access request generation unit for generating access requests of a higher priority; and a second access request generation unit for generating access requests having a lower priority and consecutiveness in the access destination address, wherein the arbitration unit issues the access requests from the first access request generation unit at the highest priority and issues the access requests from the second access request generation unit at a priority lower than that of the access requests from the second data processing section. Therefore, an arbitration is performed on the basis of the priorities of the respective access requests, thereby avoiding breakage of memory accesses.

According to claim 4 of the present invention, there is provided the information processing apparatus as defined in claim 2 wherein the access request controller comprises a buffer for accumulating data, and when an access request from the first data processing section is a write request with respect to the storage unit, the arbitration unit judges whether the arbitration unit issues an access request for writing a data amount which is requested by the write request, or accumulates a specified amount of data to be written, in the buffer, and thereafter converts the request into an access request for intensively writing the accumulated data to issue the converted access request. Therefore, priorities of the respective access requests can be judged based on whether the regularity of the access destination address is present or not.

According to claim 5 of the present invention, there is provided the information processing apparatus as defined in claim 2 wherein the access request controller comprises a buffer for accumulating data, and when an access request from the first data processing section is a read request with respect to the storage unit, the arbitration unit judges whether the arbitration unit issues an access request for reading data of an amount requested by the read request, or converts the request into an access request for intensively and previously reading more data than the requested amount by a specified amount and accumulating the read data in the buffer to issue the converted access request, or reads the data accumulated in the buffer without issuing an access request. Therefore, priorities of the respective access requests can be judged based on whether the regularity of the access destination address is present or not, and further when data are accumulated in the buffer, the data are read from the buffer, thereby reducing accesses to the storage unit.

According to claim 6 of the present invention, there is provided the information processing apparatus as defined in claim 2 wherein when an access request from the first data processing section is periodically generated at regular time intervals, the arbitration unit issues the access request at a priority higher than that of access requests from the second data processing section, and when an access request from the first data processing section is continuously generated with no time interval after an access request is accomplished, the arbitration unit issues the access request at a priority lower than that of access requests from the second data processing section. Therefore, priorities of the respective access requests can be judged based on whether the periodicity of the regularity in occurrence of an access factor is present or not.

According to claim 7 of the present invention, there is provided the information processing apparatus as defined in any of claims 1 to 6 wherein the first data processing section comprises: a demodulating and writing means for demodulating data recorded in a storage medium which can be accessed by the first data processing section and writing the demodulated data into the storage unit; an error correction means for reading data written in the storage unit and writing error-corrected data obtained by error-correcting the read data into the storage unit; an error detection means for reading the data which have been error-corrected from the storage unit and checking the data for error; and a reading means for reading data which is confirmed as having no error by the error detection means, from the storage unit, and outputting the read data to the second data processing section, and when an access request from the first data processing section is generated by the demodulating and writing means, the arbitration unit sets a priority for an access request to be issued to the access arbitration unit to be higher than a priority for access requests from the second data processing section, and when an access request from the first data processing section is generated by any of the error correction means, the error detection means, and the reading means, the arbitration unit sets a priority for an access request to be issued to the access arbitration unit to be lower than a priority for access requests from the second data processing section. Therefore, priorities of the respective access requests can be judged on the basis of the kinds of access factors.

According to claim 8 of the present invention, there is provided the information processing apparatus as defined in claim 1 wherein the second data processing section or the access arbitration unit comprises an access frequency detection unit for detecting a time period during which occurrence frequency of access to the storage unit from the second data processing section is low, and notifying the access request controller of the time period, and the access request controller suppresses issuance of access requests except in the time period and promotes issuance of access requests in the time period on the basis of the notification from the access frequency detection unit. Therefore, the issuance frequency of access requests from the first data processing section can be controlled on the basis of the occurrence frequency of accesses from the second data processing section, thereby suppressing breakage of memory accesses.

According to claim 9 of the present invention, there is provided the information processing apparatus as defined in claim 1 wherein the first data processing section comprises: an error correction means for reading data written in the storage unit and writing error-corrected data obtained by error-correcting the read data into the storage unit; and a reading means for reading data which is confirmed as having no error by the error detection means, from the storage unit, and outputting the read data to the second data processing section, and the second data processing section or the access arbitration unit comprises an access frequency detection unit for detecting a start and an end of a time period during which occurrence frequency of access to the storage unit from the second data processing section is low, and notifying the access request controller of the start and the end, and the first data processing section operates the error correction means and the reading means when the start of the time period is detected by the access frequency detection unit, and the first data processing section delays or stops the operations of the error correction means and the reading means when the end of the time period is detected. Therefore, the issuance frequency of access requests generated by the error correction means and the reading means in the first data processing section can be controlled on the basis of the occurrence frequency of accesses from the second data processing section, thereby suppressing breakage of memory accesses.

### BRIEF DESCRIPTION OF THE DRAWINGS

FIG. 1 is a block diagram illustrating a configuration (a) of an information processing apparatus and a configuration (b) of an access request control circuit according to a first embodiment of the present invention.

FIG. 2 is a diagram illustrating an access state of the pre-stage processing section in the information processing apparatus according to the first embodiment of the present invention.

FIG. 3 is a diagram illustrating an access state of the pre-stage processing section and a post-stage processing section in the information processing apparatus according to the first embodiment of the present invention.

FIG. 4 is a block diagram illustrating a configuration (a) of an information processing apparatus and a configuration (b) of an access request control circuit according to a second embodiment of the present invention.

FIG. 5 is a block diagram illustrating a configuration of an information processing apparatus according to a third embodiment of the present invention.

FIG. 6 is a block diagram illustrating a configuration of a prior art information processing apparatus.

FIG. 7 is a diagram illustrating a data structure used in error correction of data read from a media.

FIG. 8 is a diagram for explaining change of access destination addresses in the demodu-transfer.

FIG. 9 is a diagram for explaining change of access destination addresses at the external code reading for the ECC read request.

FIG. 10 is a diagram illustrating an access state of only the post-stage processing section 4 in the prior art information processing apparatus.

FIG. 11 is a block diagram illustrating a configuration of an information processing apparatus in which memories are integrated.

FIG. 12 is a diagram illustrating a state where memory accesses are broken in the prior art information processing apparatus in which memories are integrated.

### BEST MODE TO EXECUTE THE INVENTION

### Embodiment 1

An information processing apparatus according to a first embodiment of the present invention will be described with reference to the drawings.

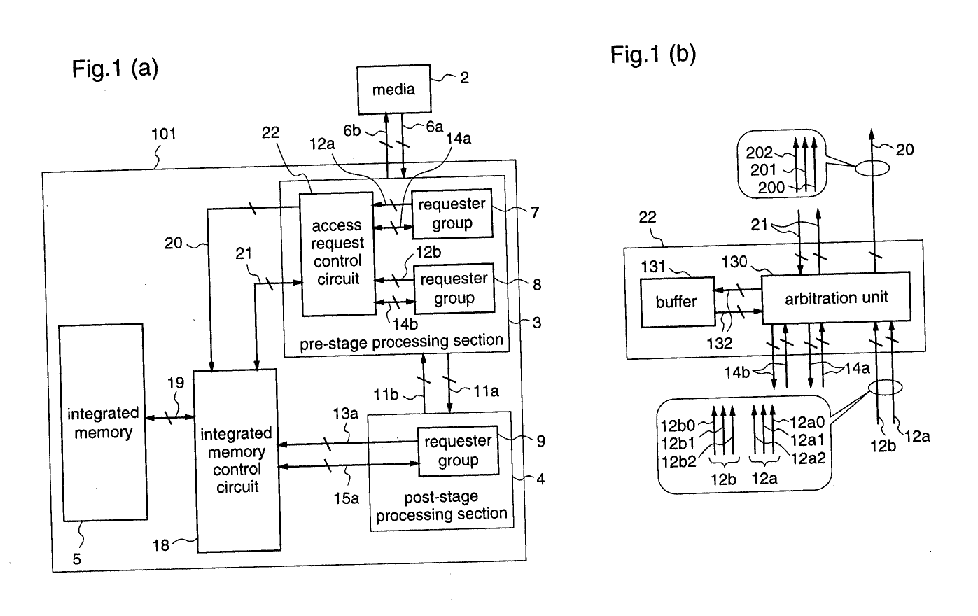

FIG. 1 is a block diagram illustrating a configuration of an information processing apparatus 101 according to the first embodiment.

The information processing apparatus 101 according to the first embodiment processes data accumulated in a media 2, and comprises a pre-stage processing section 3 for accessing the media 2, a post-stage processing section 4 for performing processing of data read from the media 2 by the pre-stage processing section 3 and creating data to be written into the media 2 by the pre-stage processing section 3, an integrated memory 5 which can be accessed by the respective processing sections, and an integrated memory control circuit 18 for arbitrating access to the integrated memory 5 from the pre-stage processing section 3 and the post-stage processing section 4.

The pre-stage processing section 3 is connected to the media 2 through data signals 6a and 6b, and has functions of either/both reading data from the media 2 or/and writing data into the media 2. In order to realize the functions, the pre-stage processing section 3 comprises a requester group 7 and a requester group 8 as factors for generating plural access requests with respect to the integrated memory 5. The requester group 7 issues plural access requests through request signals 12a which are provided by the same number as the number of access requests. Similarly, the requester group 8 issues plural access requests through request signals 12b which are provided by the same number as the number of access requests. Further, the pre-stage processing section 3 includes an access request control circuit 22 which outputs a predetermined number of access requests to the integrated memory control circuit 18 among plural access requests from the requester group 7 and the requester group 8. The access request control circuit 22 is connected to the requester group 7 through request signals 12a and a data signal 14a, to the requester group 8 through request signals 12b and a data signal 14b, and to the integrated memory control circuit 18 through request signals 20 and a data signal 21.

The access request control circuit 22 outputs a predetermined number of access requests from among plural access requests from the requester group 7 and the requester group 8, to the request signals 20 which are provided by a predetermined number so that the predetermined number of access requests can be simultaneously output, and includes an arbitration unit 130 which temporarily accumulates the supplied data in the buffer 131, as having a configuration shown in FIG. 1(b). The arbitration unit 130 is connected to the requester group 7 through request signals 12a and the data signal 14a and to the requester group 8 through request signals 12b and the data signal 14b. Further, the arbitration unit 130 is connected to the buffer 131 through a data signal 132 and to the integrated memory control circuit 18 through the request signals 20 and the data signal 21.

The arbitration unit 130 has a function of judging whether each of the access requests from the requester group 7 and the requester group 8 is to be issued to the integrated memory control circuit 18 as a request of one word length as it is or each of the access requests is to be converted into a transfer request of consecutive longer transfer length such as multiple-word lengths and issued so as to temporarily accumulate the data supplied according to the access requests in the buffer 131 (hereinafter, referred to as bursting judgement), and a function of judging at what priority among plural stages of priorities an access request is to be issued when the access request is issued to the integrated memory control circuit 18. The access factor for which access destination addresses change with regularity is an access factor which can be burst, and therefore the access factor is converted into an access request of longer transfer length to be outputted, while the other access factors are access factors which cannot be burst, and therefore each of the access factors is output as an access request of one word length as it is. Here, the respective signals of the request signals 20 are set to different priorities, respectively, and the arbitration unit 130 outputs an issued access request to a signal for which a priority corresponding to a priority for the access request is set. That is, the arbitration unit 130 issues an access request generated by an access factor which cannot be burst, and an access request generated by an access factor which can be burst and for which transfer requests are always generated at regular intervals, through a request-signal of a higher priority among the request signals 20. On the other hand, the arbitration unit 130 issues an access request generated by an access factor which can be burst and is continuously generated with no time interval after a request is accomplished, through a request signal of a lower priority among the request signals 20.

Here, in a case where the media 2 is a DVD and the information processing apparatus 101 is an apparatus which reads data recorded on the DVD and outputs a video signal and an audio signal, the requester group 7 comprises three access factors of a CPU request from a central processing unit (not shown) which controls the information processing apparatus 1, a demodu-request for demodulating data read from the media 2 and writing the demodulated data into the integrated memory 5, and an ECC correction request for correcting error data found in the error correction. In this case, three signals of 12a0 to 12a2 which transmit the respective access requests are provided as request signals 12a, and the CPU request, the demodu-request, and the ECC correction request are input to the arbitration unit 130 in the access request control circuit 22, through the signal 12a0, the signal 12a1, and the signal 12a2, respectively.

Further, the requester group 8 comprises three access factors of an ECC read request for performing error correction of data which was written according to the demodu-request, and an EDC request for checking whether an error is left on the error-corrected data, and a HOST transfer request for outputting data which is confirmed as having no error to the data signal 11a. In this case, three signals of 12b0 to 12b2 which transmit the respective access requests are provided as request signals 12b, and the ECC read request, the EDC request, and the HOST transfer request are input to the arbitration unit 130 in the access request control circuit 22, through the signal 12b0, the signal 12b1, and the signal 12b2, respectively.

Furthermore, three signals of a first priority request signal 200, a second priority request signal 201, and a third priority request signal 202 in descending order of priority are provided as request signals 20 for outputting access requests through signals 12a0 to 12a2 and signals 12b0 to 12b2 to the integrated memory 5. The first priority request signal 200 of the highest priority is occupied by the CPU request, the second priority request signal 201 of the highest priority but the first priority request signal 200 is shared by the demodu-request and the ECC correction request, and the third priority request signal 202 of the lowest priority is shared by the ECC read request, the EDC request, and the HOST transfer request.

The post-stage processing section 4 is connected to the pre-stage processing section 3 through a data signal 11a and a data signal 11b, and has functions of either/both performing processing of data which are read from the media 2 by the pre-stage processing section 3 or/and creating data to be written into the media 2 by the pre-stage processing section 3. Further, the post-stage processing section 4 includes a requester group 9 as factors for generating plural access requests with respect to the integrated memory 5. The requester group 9 issues plural access requests through request signals 13a which are provided by the same number as the number of access factors, and is connected to the integrated memory control circuit 18 through the request signals 13a and a data signal 15a.

The integrated memory control circuit 18 arbitrates among the access requests from the pre-stage processing section 3 (request signals 20) and the access requests from the post-stage processing section (request signals 13a). In a case where the information processing apparatus 101 accesses a DVD, the access request of the first priority request signal 200 is adapted to have the highest priority, and then the access requests of the second priority request signal 201, the access requests of the request signals 13a, and the access requests of the third priority request signal 202 are adapted to have the lower priorities in this order, at the arbitration.

The integrated memory 5 is an SDRAM of 16 bit width. Hereinafter, a case where an address of the integrated memory 5 is indicated by a logical address of one word length of 32 bits will be described as an example.

Next, an operation of the information processing apparatus 101 constructed as above will be described with taking, as an example, a case where the media 2 is a DVD and the information processing apparatus 101 is an apparatus for accessing the DVD.

The arbitration unit 130 in the access request control circuit 22 arbitrates among the request signals 12a output from the requester group 7 and the request signals 12b output from the requester group 8 as follows.

That is, when the arbitration unit 13 receives a CPU request (request signal 12a0), the arbitration unit 130 judges that the request cannot be burst, and immediately issues an access request of transfer word length 1 as an access request requiring a higher priority through the first priority request signal 200. In a case where contents of the access request are write request, the arbitration unit 130 wait for a permission from the integrated memory control circuit 18 to output data of the data signal 14a to the data signal 21, and notifies the requester group 7 of the accomplishment of the access request. In a case where contents are read request, the arbitration unit 130 wait for a permission from the integrated memory control circuit 18 to output data of the data signal 21 to the data signal 14a, and notifies the requester group 7 of the accomplishment of the access request.

When the arbitration unit 130 receives a demodu-request (request signal 12a1), the arbitration unit 130 judges that the request is an access request which can be burst. Then, the arbitration unit 130 outputs data of the media 2, which are supplied through the data signal 14a, to the data signal 132 to accumulate the data in the buffer 131, and notifies the requester group 7 of the accomplishment of the access request. This operation will be repeated, and when a requested transfer length of the demodu-request is X, data of word length X are accumulated in the buffer 130. When data of word length X are accumulated in the buffer 131, the arbitration unit 130 issues a write request for word length X to the second priority request signal 201. Here, the demodu-request is an access factor which generates an access request at regular time intervals, and thereby the demodu-request is output to the second priority request signal 201 as an access request of a higher priority. However, in a case where an access request has already been issued to the second priority request signal 201 by the ECC correction request and the request has not been accomplished, the arbitration unit 130 causes the demodu-request to wait until the ECC correction request is accomplished.

When the demodu-request is output to the second priority request signal 201, the arbitration unit 130 waits for a permission from the integrated memory control circuit 18 to consecutively read data of word length X accumulated in the buffer 131 through the data signal 132, and outputs the read signal to the data signal 21. As described above, the demodu-request is an access request generated at regular time intervals. For example, when the DVD operates at double speed, the data to be written according to the demodu-request are generated at a rate of approximately one word length per 1.25 μs. Therefore, in a case where data of X word length are accumulated and then an access request to the integrated memory control circuit 18 is issued, the interval at which the access request is issued is approximately 1.25 Xμs.

When the arbitration unit 130 receives an ECC correction request (request signal 12a2), the arbitration unit 130 judges that the request is an access request which cannot be burst, and immediately issues an access request of transfer word length 1 as an access request requiring a higher priority through the second priority request signal 201. Then, the arbitration unit 130 waits for a permission from the integrated memory control circuit 18 to output the correction data to the data signal 21 and notifies the requester group 7 of the accomplishment of the request. However, in a case where when the ECC correction request is input to the arbitration unit 130, an access request has already been issued to the second priority request signal 201 by the demodu-request and the request has not been accomplished, the arbitration unit 130 causes the ECC correction request to wait until the demodu-request is accomplished.

When the arbitration unit 130 receives an ECC read request (request signal 12b0), the arbitration unit 130 judges that the request is an access request which can be burst, and issues an access request of k word length as a transfer length through the third priority request signal 202 as an access request for which a lower priority is to be set. However, in a case where an access request has already been issued to the third priority request signal 202 by the EDC request or the HOST transfer request, and the request has not been accomplished, the arbitration unit 130 causes the ECC read request to wait until the request is accomplished.

After the ECC read request is output, the arbitration unit 130 waits for a permission from the integrated memory control circuit 18 to consecutively output data of k word length from the data signal 21 to the data signal 132 and write the data into the buffer 131. Then, data corresponding to the access destination address are output to the data signal 14b and the requester group 8 is notified of the accomplishment of the request.

Here, realization of the ECC read request will be described in more detail.

In the case of external code reading, when an address requested to be accessed is pd which is a head of the data area D1, the data reading up to the address pd+ko which is ahead of the address pd by ko is required. That is, the transfer length k is given as k=ko+1. These read data of addresses pd+1, pd+2, . . . , pd+ko are data corresponding to n times later, 2n times later, . . . , (ko×n) times later ECC read requests, respectively. Therefore, the data accumulated in the buffer may be transferred for n times later, 2n times later, . . . , (ko×n) times later ECC read requests, and accesses to the integrated memory 5 are unnecessary. In a method in which data of one word length is read from the integrated memory 5 every time an access request is generated, the performance of the integrated memory is degraded. However, when previous reading is performed by (ko+1) word length reading as described above, the access can be converted into consecutive access for (ko+1) word length. On the other hand, in the case of internal code reading, when an address pd is required to be accessed, data reading up to an address which is ahead of the address pd by a natural number ki is required. That is, transfer length k is given as k=ki+1. Therefore, in this case, the access can be converted into consecutive access for ki+1 word length.

On the other hand, in a case where the data of the address required by the ECC read request (request signal 12b0) is read by the previous access request and have already been included in the buffer 131, the arbitration unit 130 does not issue an access request to the third priority request signal 202, and outputs the corresponding data in the buffer 131 to the data signal 14b through the data signal 132, and reports the accomplishment of the access request.

When the arbitration unit 130 receives an EDC request (request signal 12b1), the arbitration unit 130 issues an access request through the third priority request signal 202. However, in a case where an access request has already been issued to the third priority request signal 202 by an ECC read request or a HOST transfer request, and the request has not been accomplished, the arbitration unit 130 causes the EDC request to wait until the request is accomplished and no ECC read request is waiting.

Here, when an access destination address is p and a requested transfer length is k1+1, the EDC request requires that data of addresses p to p+k1 be read. The arbitration unit 130 waits for a permission from the integrated memory control circuit 18 to consecutively output the data of k1+1 word length through the data signal 21 to the data signal 132, writes the data into the buffer 131, outputs data corresponding to address p to the data signal 14b, and notifies the requester group 8 of the accomplishment of the request.

On the other hand, in a case where data of the address requested by the EDC request are read by the previous access request and have already been included in the buffer 131, the arbitration unit 130 does not issue an access request to the third priority request signal 202, outputs the corresponding data in the buffer 131 to the data signal 14b through the data signal 132, and reports the accomplishment of the access request.

When the arbitration unit 130 receives a HOST transfer request (request signal 12b2), the arbitration unit 130 issues an access request through the third priority request signal 202. However, in a case where an access request has already been issued to the third priority request signal 202 by an ECC read request or an EDC request, and the request has not been accomplished, the arbitration unit 130 causes the HOST transfer request to wait until the request is accomplished and there are no waiting ECC read request and EDC request.

Here, when an access destination address is p and a requested transfer length is k2+1, the arbitration unit 130 requests that data of addresses p to p+k2 be read. Then, the arbitration unit 130 waits for a permission from the integrated memory control circuit 18 to consecutively output data of K2+1 word length from the data signal 21 to the data signal 132, writes the data into the buffer 131, outputs data corresponding to address p to the data signal 14b, and notifies the requester group 8 of the accomplishment of the request.

On the other hand, in a case where data of the address p requested by the HOST transfer request are read by the previous access request and have already been included in the buffer 131, the arbitration unit 130 does not issue an access request to the third priority request signal 202, outputs the corresponding data in the buffer 131 to the data signal 14b through the data signal 132, and reports the accomplishment of the access request.

Next, a description concerning that the access request control circuit 22 arbitrates among access factors of the pre-stage processing section 3 as described above, thereby avoiding the breakage of memory access of the pre-stage processing section 3 and the breakage of memory access of the post-stage processing section 4, will be given.

The worst value of the occupied bandwidth inclusive of overhead for the pre-stage processing section 3 is given by the following formula using the respective values of a requested transfer length of the respective access factors, X, ko, ki, k1, and k2.
18.6+16.1(1/X+1/(ko+1)+1/(ki+1))+2.45+13.9(1/(k1+1)+1·(k2+1))

Using this formula, X, ko, ki, k1, and k2 are determined so that the whole bandwidth of the information processing apparatus 1 is within the bandwidth of the integrated memory 5, thereby avoiding breakage of bandwidth substantially.

Subsequently, as to the respective access factors of the pre-stage processing section 3, it is discussed whether the memory access can be normally accomplished or not.

The CPU request has the highest priority of all the access requests, and exclusively occupies the first priority request signal 200. Therefore, even under the worst condition, its waiting time is the shortest of all the access factors, thereby meeting the requirements of quick response to the memory access.

The demodu-request shares, with an ECC correction request, the second priority request signal 201 having the highest priority but the first priority request signal 200. Therefore, the demodu-request is not caused to wait by access factors other than a CPU request and an ECC request, thereby obtaining quick response.

The ECC correction request shares the second priority request signal 201 with a demodu-request. The ECC correction request is issued to the integrated memory control circuit 18 as a single-shot write request of one word length. In a case where the ECC correction request, which cannot be burst, is issued using the third priority request signal 202, the problem described below occurs. Further, using the first priority request signal 200 causes the waiting time to be generated for the CPU request, and it is not desirable. Therefore, the second priority request signal 201 is used for the ECC correction request. Then, the ECC correction request is not caused to wait by the access factors other than a CPU request and a demodu-request, thereby avoiding breakage of processing due to delay in memory access.

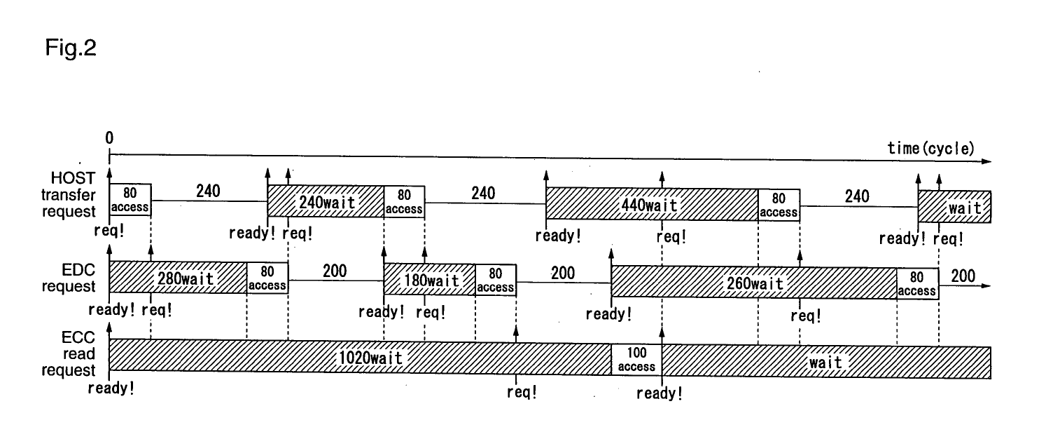

The ECC read request, the EDC request, and the HOST transfer request share the third priority request signal 202 having a priority lower than the request signals 13a from the post-stage processing section 4. These access factors can be burst, and therefore these access factors are issued as access requests of longer requested transfer length. Further, for these access factors, the access requests are issued independently from each other in progress of processing, and the access requests can be continuously issued as shown in FIG. 2. FIG. 2 shows access states of the ECC read request, the EDC request and the HOST transfer request, and a location where “req” is described designates a time at which an access request is issued, an area where “access” is described designates a time period during which data transfer is being performed, and an area where “wait” is described designates a waiting time. For the ECC read request, the EDC request, and the HOST transfer request, access requests are issued independently from each other in progress of processing as shown in FIG. 2, and therefore access can be intensively accomplished. Thus, it is a sufficient condition for completing the ECC read request, the EDC request and the HOST transfer request without being broken that there is a room in the bandwidth.

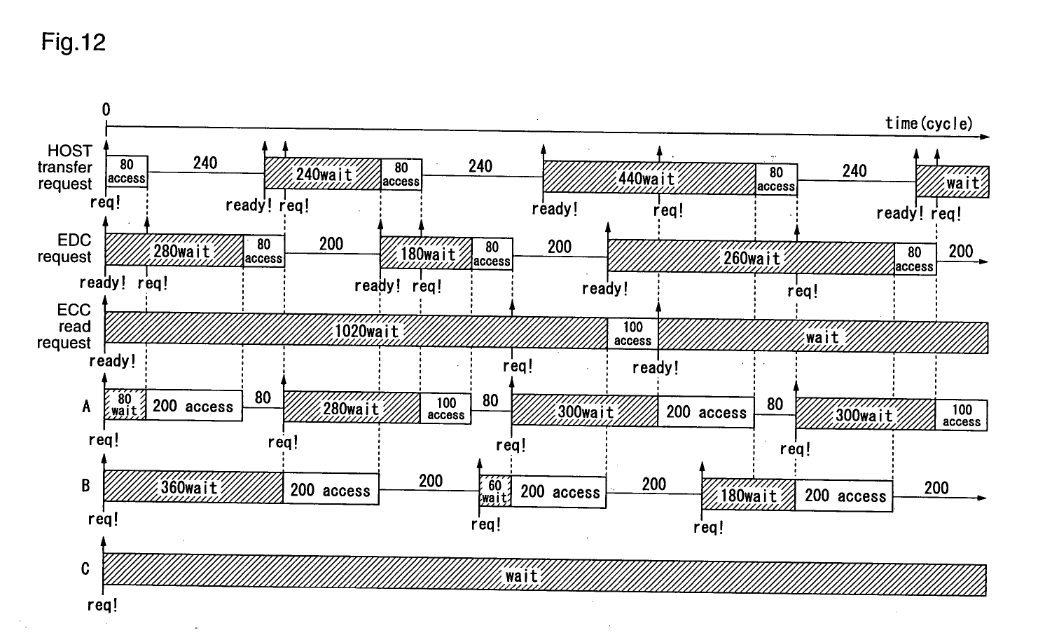

If X, ko, ki, k1, and k2 are properly defined in the above-described formula and thereby the whole bandwidth of the information processing apparatus 101 falls within the bandwidth of the integrated memory 5 with a room of approximately 10%, even when the third priority request signal 202 has the lowest priority of all the access factors, breakage of processing due to delay in memory access can be avoided. On the other hand, when access factors of the post-stage processing section 4 for which the access requests are arbitrated so as to have a priority lower than the third priority request signal 202 is assumed, the operation will be in a state similar to that in the case shown in FIG. 12, and there is a possibility that for the access factors for which the access requests are arbitrated so as to have a priority lower than the third priority request signal 202, the access requests cannot be accomplished until an ECC read request, an EDC request, and a HOST transfer request are all accomplished. Therefore, it is necessary that the third priority request signal 202 should have the lowest priority of all the access factors which are arbitrated by the arbitration unit 130. Assuming that the third priority request signal 202 is used for the ECC correction request, the following matter would occur because the ECC correction request is a single-shot write request in units of one word length. For example, in a case where the request of the third priority request signal 202 is accepted 10 times, the transfer of 10 bytes in total is only accomplished for the ECC correction request, while transfer of 160 word length or more is possible for the ECC read request, the EDC request, and the HOST transfer request. That is, the frequency with which the third priority request signal 202 may be transferred is little, and when ECC correction request is transferred through the third priority request signal 202, there is a possibility that the ECC read request, the EDC request, and the HOST transfer request may be delayed. Therefore, it is appropriate that the third priority request signal 202 is not used for the ECC correction request.

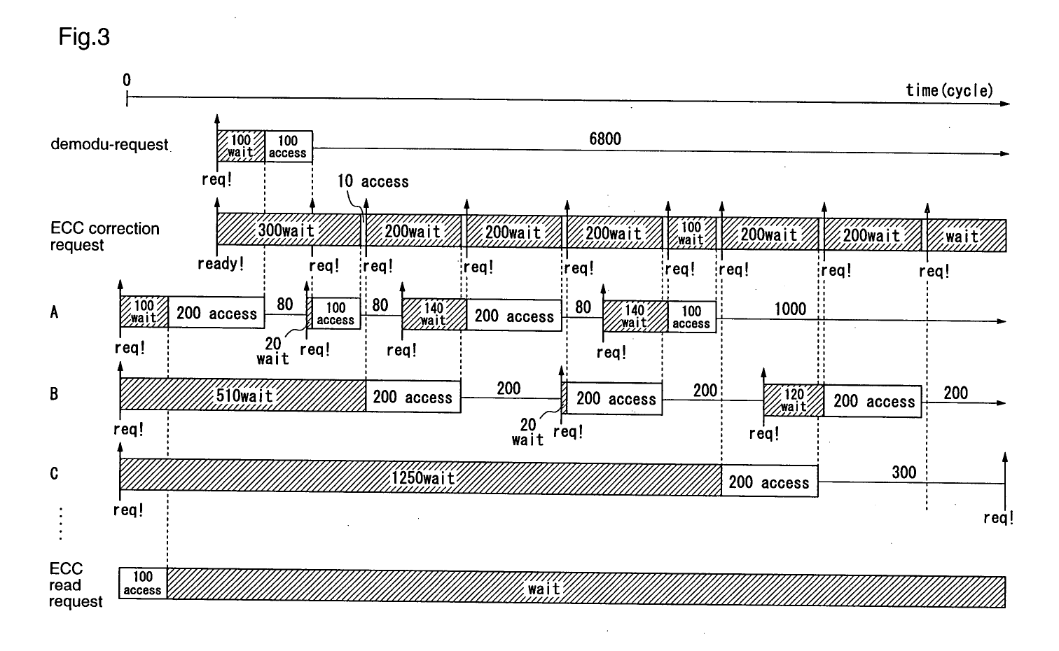

Further, as for the information processing apparatus 101, reviewing the access states for the access factors of the post-stage processing section 4 in the worst condition described above, the states are as shown in FIG. 3. FIG. 3 shows access states for an ECC read request, an EDC request, a HOST transfer request, and access factors A to C of the post-stage processing section 4. It is assumed that the ECC read request is accepted, and thereafter the access requests for the access factors A, B, and C of the post-stage processing section 4 are issued at the same timing, and a demodu-request and an ECC correction request are issued when the access request for access factor A is being executed. The demodu-request is converted by being burst to issue a request for occupying the integrated memory 5 for 10N cycles inclusive of overhead. Further, with this bursting, an interval at which an access request to the integrated memory control circuit 18 for the demodu-request is issued, is 700N cycles.

For an ECC correction request, an access request of one word length is issued up to 16 times. An access to the integrated memory 5 for one ECC correction request takes only N cycles, thereby completing the access in a short time. Therefore, even when an access to the integrated memory 5 for the ECC correction request is performed after the access factors A and B are completed, the subsequent access requests are not issued for the access factors A and B, thereby also accepting the access request for the access factor C.

As described above, since a transfer length of the ECC correction request is shorter, even when an extremely high priority is set for the ECC correction request, access factors of lower priorities are not affected. An ECC read request, an EDC request, and a HOST transfer request have the lowest priority, and thereby the access requests are not accepted in a time period during which accesses of the post-stage processing section 4 are frequently performed as shown in FIG. 3, and the access requests of the post-stage processing section 4 are not prevented. Consequently, even under the worst condition, a micro memory access breakage of the post-stage processing section 4 is avoided.

As described above, in the information processing apparatus 101 according to the first embodiment, the pre-stage processing section 3 in which the access request control circuit 22 arbitrates among plural access requests with respect to the integrated memory 5 and which issues a predetermined number of access requests, the post-stage processing section 4 which issues plural access requests with respect to the integrated memory 5, and the integrated memory control circuit 18 which arbitrates among access requests from the pre-stage processing section 3 and the post-stage processing section 4 and outputs any of the access requests to the integrated memory 5, are provided, and the access request control circuit 22 and the integrated memory control circuit 18 are adapted to perform arbitration on the basis of periodicities of the respective access factors and regularity of the access destination address. Therefore, the pre-stage processing section 3 and the post-stage processing section 4, which have the different data transfer rates, can share the integrated memory 5 without breaking the memory access. With this, a low-speed memory accessed by the pre-stage processing section 3 can be dispensed with, and moreover the pre-stage processing section 3 and the post-stage processing section 4 can be formed in a single semiconductor integrated circuit, thereby reducing the number of components and a footprint and reducing production cost.

Then, while in this embodiment two step arbitrations by the integrated memory control circuit 18 and the access request control circuit 22 is performed for the access requests of the pre-stage processing section 3, the integrated memory control circuit 18 may arbitrate the access requests of the pre-stage processing section 3. For example, the integrated memory control circuit 18 may be provided with channels corresponding to the number of all the access factors of the pre-stage processing section 3, and the buffer 131 included in the access request control circuit 22, and arbitrate among access requests from the pre-stage processing section 3 and the post-stage processing section 4 based on the same reference as that of the access request control circuit 22, that is, whether the access request can be burst and whether the access request is consecutively issued or periodically issued. In this case, the integrated memory control circuit 18 is dispensed with, thereby reducing a circuit scale of the information processing apparatus.

### Embodiment 2

An information processing apparatus according to a second embodiment of the present invention will be described with reference to the drawings. The second embodiment is an example in which an additional constituent is added to the information processing apparatus 101 according to the first embodiment.

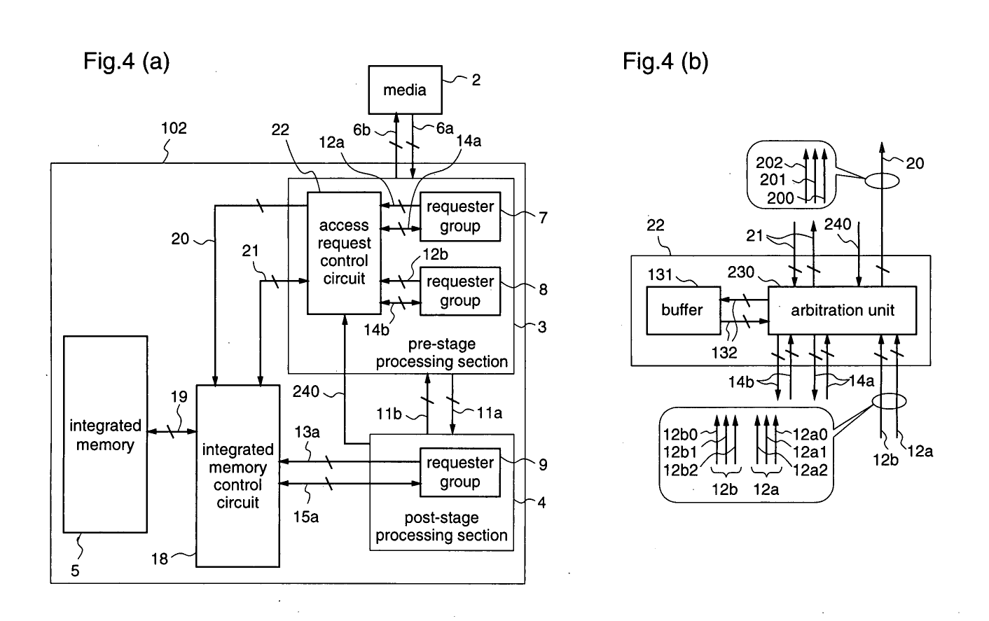

FIG. 4 is a block diagram illustrating a configuration of the information processing apparatus 102 according to the second embodiment. Then, in FIG. 4, the same reference numerals as those shown in FIG. 1 denote the same or corresponding portions, and the detailed description will be omitted.

In FIG. 4, reference numeral 240 denotes an access frequency notification signal which notifies an arbitration unit 230 in the access request control circuit 22 of the pre-stage processing section 3 whether data are being decoded by the post-stage processing section 4 or not.

Data supplied from the pre-stage processing section 3 are not always being decoded by the post-stage processing section 4 when the information processing apparatus 1 is in operation, and a time period during which no decoding is performed occurs. For example, when the supplied data are compressed image data, a time period during which no decoding is performed occurs every one frame as a unit of image processing. Hereinafter, this time period is referred to as a blank period.

Next, an operation of the information processing apparatus 102 constructed as above will be described.

The post-stage processing section 4 notifies the access request control circuit 22 of the information as to whether the post-stage processing section 4 is in a blank period or not. The access frequency notification signal 240 is a signal which becomes HI during the blank period and becomes LOW except during the blank period.

In the access request control circuit 22, the arbitration unit 230 refers to the access frequency notification signal 240 to obtain the information as to whether the post-stage processing section 4 is in a blank period or not, and controls issuance of access requests.

That is, when the post-stage processing section 4 is not in a blank period, the arbitration unit 230 issues access requests to the integrated memory control circuit 18 at regular time intervals. On the other hand, when the post-stage processing section 4 is in a blank period, the arbitration unit 230 issues access requests to the integrated memory control circuit 18 with no time interval.

As described above, in the information processing apparatus 102 according to the second embodiment, an access frequency notification signal 240 indicating whether the post-stage processing section 4 is in a blank period or not is input to the arbitration unit 230, and the arbitration unit 230 issues access requests to the integrated memory control circuit 18 at regular time intervals when the post-stage processing section 4 is not in a blank period, while the arbitration unit 230 issues access requests to the integrated memory control circuit 18 with no time interval when the post-stage processing section 4 is in a blank period, and thereby the access requests from the pre-stage processing section 3 do not cause the processing of the post-stage processing section 4 to be delayed. At this time, occurrence of waiting times caused by the access requests from the post-stage processing section 4 can be avoided for an EDC request, a HOST transfer request, and the like, thereby intensively accomplishing access requests.

Further, even if an EDC request, a HOST transfer request, and an ECC read request are not always issued at a lower priority, the access requests of the requester group 9 cannot be prevented by the operation of the arbitration unit 230. Therefore, a configuration in which the third priority request signal 202 of the first embodiment is deleted is possible. In this case, the circuit scales of the integrated memory control circuit 18 and the access request control circuit 22 can be reduced.

### Embodiment 3

An information processing apparatus according to a third embodiment of the present invention will be described with reference to the drawings. The third embodiment is an example of a modification of the information processing apparatus 101 according to the first embodiment, which is obtained by adding an additional element such as a software to the apparatus 101.

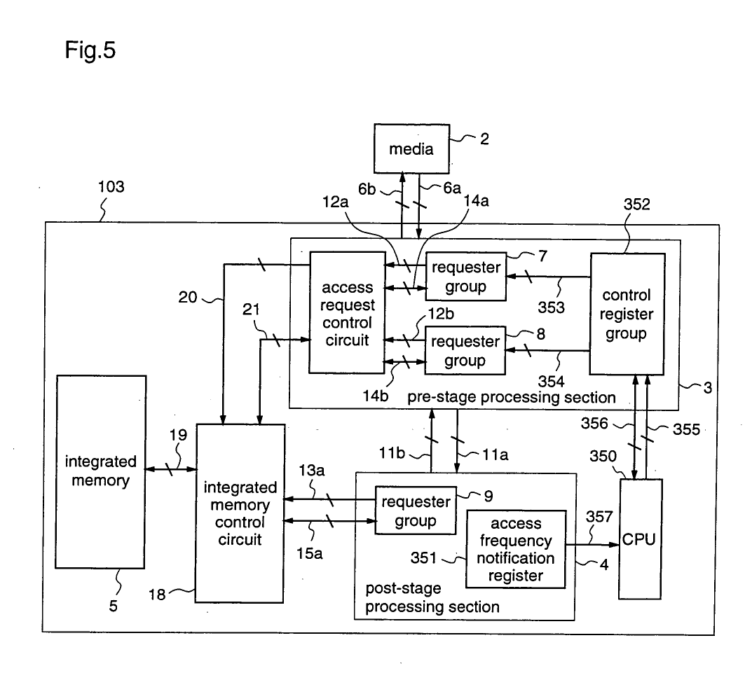

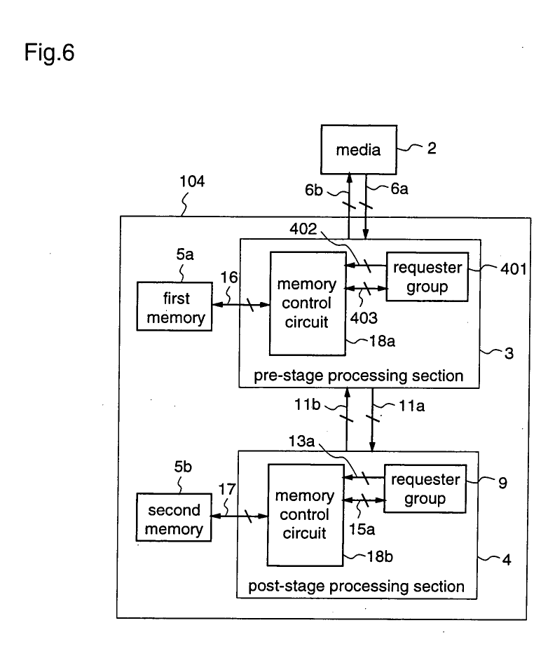

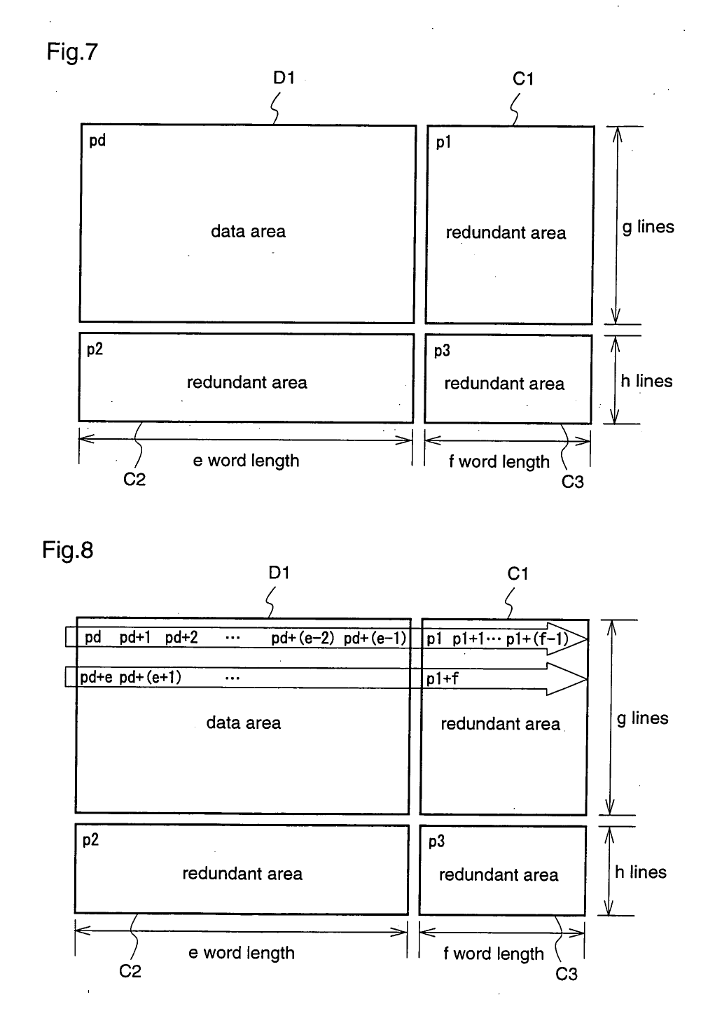

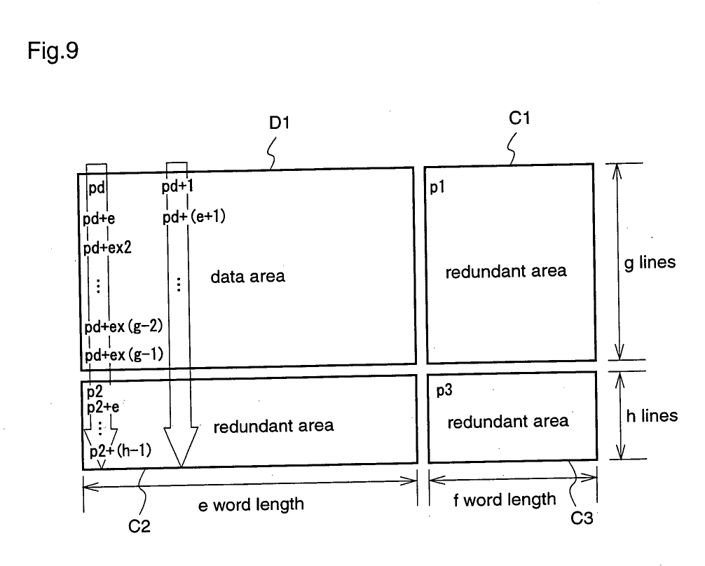

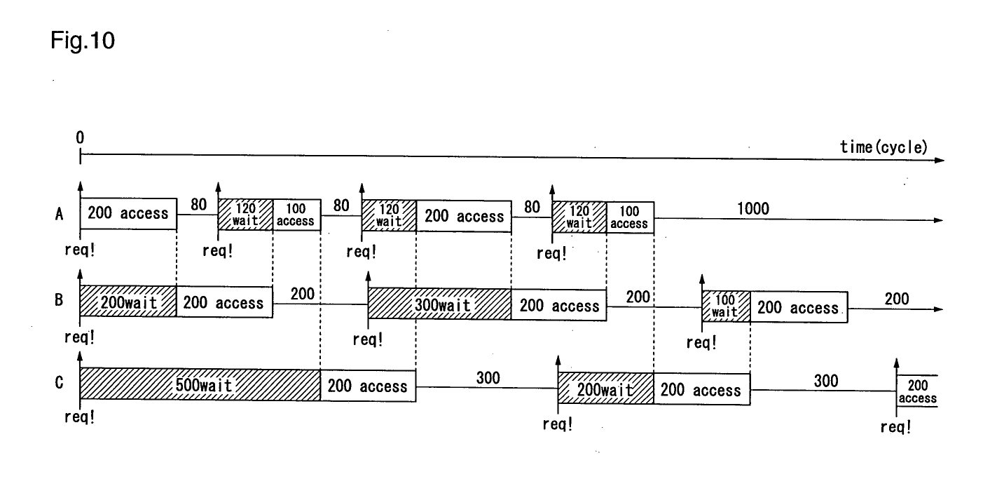

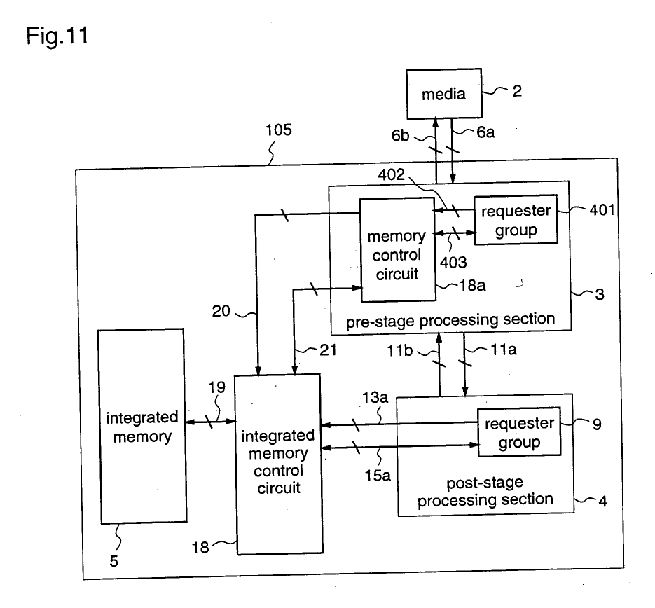

FIG. 5 is a block diagram illustrating a configuration of the information processing apparatus 103 according to the third embodiment. Then, in FIG. 5, the same reference numerals as those shown in FIG. 1 denote the same or corresponding portions, and the detailed description will be omitted.

In FIG. 5, reference numeral 351 denotes an access frequency register in which a setting as to whether the post-stage processing section 4 is in a blank period or not is performed, reference numeral 352 denotes a control register group comprising plural registers in which modes are set, respectively, and reference numeral 350 denotes a CPU which sets a mode in any of the registers in the control register group 352 on the basis of the setting value of the access frequency notification register 351. Further, the CPU 350 is connected to the access frequency notification register 351 through an access frequency notification signal 357, and to the control register group 352 through an address signal 355 and a data signal 356. The control register group 352 is connected to the requester group 7 through a data signal 353 and to the requester group 8 through a data signal 354.

The CPU 350 selects a specific register in the control register group 352 through the address signal 355, and can freely set a value in the selected register through the data signal 356.

The control register group 352 is provided with the registers by the same number as the number of access factors of the requester group 7 and the requester group 8, and as for the respective access factors of the requester group 7 and the requester group 8, a value of the corresponding register in the control register group 352 can be referred to through the data signal 353 or the data signal 354.

Here, in a case where the setting values of the control register group 352 indicate operation modes for the respective request factors, the CPU 350 can set the operation modes for the respective access factors of the requester group 7 and the requester group 8 through the control register group 352.

Hereinafter, the operation modes for the respective access factors will be described.

The access factor is the same between the ECC read request and the ECC correction request, and the access factor has two modes of a normal ECC mode for performing error correction processing at the highest possible speed and an ECC stop mode in which no error correction processing is performed. In the normal ECC mode, when an ECC read request is accomplished, the subsequent ECC read request is generated with NoWait. On the other hand, an ECC read request and an ECC correction request are not generated in the ECC stop mode.

The access factor of the EDC request has two modes of a normal EDC mode for performing error detection processing at the highest possible speed and an EDC stop mode in which no error correction processing is performed. In the normal EDC mode, when a request is accomplished for the access factor of the EDC request, the subsequent EDC request is generated with NoWait. On the other hand, no EDC request is generated in the EDC stop mode.

The access factor of the HOST transfer request has two modes of a normal HOST transfer mode for performing the HOST transfer processing at the highest possible speed and a HOST transfer stop mode in which no HOST transfer processing is performed. In the normal HOST transfer mode, when a HOST transfer request is accomplished, the subsequent HOST transfer request is generated with NoWait. On the other hand, no HOST transfer request is generated in the HOST transfer stop mode.

Next, an operation of the information processing apparatus 102 constructed as above will be described.

The post-stage processing section 4 sets 1 in the access frequency notification register 351 when the post-stage processing section 4 is in a blank period and otherwise it sets 0.

The CPU 350 detects a setting value in the access frequency notification register 351 using the access frequency notification signal 240. When the post-stage processing section 4 is in a blank period, the CPU 350 sets values in the control register group 352 through the address signal 355 and the data signal 356, thereby to set the operation mode of the access factor of the ECC read request, the operation mode of the access factor of the EDC request, and the operation mode of the access factor of the HOST transfer request, to the normal ECC mode, the normal EDC mode, and the normal HOST transfer mode, respectively.

On the other hand, when the post-stage processing section 4 is not in a blank period, the CPU 350 sets values in the control register group 352 through the address signal 355 and the data signal 356 so that the operation mode of the access factor of the ECC read request is periodically and alternately changed to the normal ECC mode and the ECC stop mode, the operation mode of the access factor of the EDC request is periodically and alternately changed to the normal EDC mode and the EDC stop mode, the operation mode of the access factor of the HOST transfer request is periodically changed to the normal HOST transfer mode or the HOST transfer stop mode.

Alternatively, when the post-stage processing section 4 is not in a blank period, the CPU 350 may set the access factor of the ECC read request, the access factor of the EDC request, and the access factor of the HOST transfer request mode, to the ECC stop mode, the EDC stop mode, and the HOST transfer stop mode, respectively.

As described above, the information processing apparatus 102 according to the third embodiment comprises the access frequency register 351 in which setting as to whether the post-stage processing section 4 is in a blank period or not is performed, the control register group 352 comprising plural registers in which modes are set, and the CPU 350 for setting a mode in any of the registers in the control register group 352 on the basis of the setting value in the access frequency notification register 351. Therefore, when the post-stage processing section 4 is not in a blank period, the operation mode of the access factor of the ECC read request is periodically and alternately changed to the normal ECC mode and the ECC stop mode, the operation mode of the access factor of the EDC request is periodically and alternately changed to the normal EDC mode and the EDC stop mode, and the operation mode of the access factor of the HOST transfer request is periodically changed to the normal HOST transfer mode or the HOST transfer stop mode, on the basis of the setting in the control register group 352. Thereby, the access requests from the pre-stage processing section 3 do not cause the processing of the post-stage processing section 4 performed during the time periods other than a blank period to be delayed. Further, when the post-stage processing section 4 is in a blank period, no access request of the requester group 9 is generated, and therefore access requests of the requester group 8 are generated with NoWait, thereby intensively accomplishing the access requests of the requester group 8.

Further, even if the respective access requests of the ECC read request, the EDC request, and the HOST transfer request are not always issued at a lower priority, access requests of the requester group 9 are not prevented by the operation of the arbitration unit 130. Therefore, a configuration in which the third priority request signal 202 of the first embodiment is deleted is possible. In this case, the circuit scales of the integrated memory control circuit 18 and the access request control circuit 22 can be reduced.

### APPLICABILITY IN INDUSTRY

An information processing apparatus of the present invention is useful because memory accesses to one storage unit from plural processing sections are performed without breaking the memory accesses, thereby reducing the number of components and production cost.

1-9. (canceled)

10. An information processing apparatus comprising:
a storage unit for storing data;
a first data processing section for issuing plural access requests by a first access request generation unit for generating access requests of a higher priority and a second access request generation unit for generating access requests having a lower priority and consecutiveness in access destination address, and accessing the storage unit;
a second data processing section for issuing access requests and accessing the storage unit;
an access request controller having an arbitration unit for adding the highest priority to the access requests from the first access request generation unit, and adding a priority lower than that of the access requests from the second data processing section to the access requests from the second access request generation unit, the access request controller arbitrating among plural access requests from the first data processing section to output a predetermined number of access requests; and
an access arbitration unit for arbitrating among the access requests from the access request controller and the access requests from the second data processing section.

11. The information processing apparatus as defined in claim 10, wherein
the access request controller comprises a buffer for accumulating data, and
when an access request from the first data processing section is a write request with respect to the storage unit, the arbitration unit judges whether the arbitration unit issues an access request for writing a data amount which is requested by the write request, or accumulates a specified amount of data to be written, in the buffer, and thereafter converts the request into an access request for intensively writing the accumulated data to issue the converted access request.

12. The information processing apparatus as defined in claim 10, wherein
the access request controller comprises a buffer for accumulating data, and
when an access request from the first data processing section is a read request with respect to the storage unit, the arbitration unit judges whether the arbitration unit issues an access request for reading data of an amount requested by the read request, or converts the request into an access request for intensively and previously reading more data than the requested amount by a specified amount and accumulating the read data in the buffer to issue the converted access request, or reads the data accumulated in the buffer without issuing an access request.

13. The information processing apparatus as defined in claim 10, wherein
the first data processing section
issues access requests which are periodically generated at regular time intervals, from the first access request generation unit, and
issues access requests which are consecutively generated with no time interval after an access request is accomplished, from the second access request generation unit.

14. The information processing apparatus as defined in claim 10, wherein
the first data processing section comprises:
a demodulating and writing means for demodulating data recorded in a storage medium which can be accessed by the first data processing section and writing the demodulated data into the storage unit;
an error correction means for reading data written in the storage unit and writing error-corrected data obtained by error-correcting the read data into the storage unit;
an error detection means for reading the data which have been error-corrected from the storage unit and checking the data for error; and
a reading means for reading data which is confirmed to have no error by the error detection means, from the storage unit, and outputting the read data to the second data processing section, and
when an access request from the first data processing section is generated by the demodulating and writing means, the arbitration unit sets a priority of an access request to be issued to the access arbitration unit higher than a priority of access requests from the second data processing section, and
when an access request of the first data processing section is generated by any of the error correction means, the error detection means, and the reading means, the arbitration unit sets a priority of an access request to be issued to the access arbitration unit lower than a priority of access requests from the second data processing section.

15. The information processing apparatus as defined in claim 10, wherein
the second data processing section or the access arbitration unit comprises an access frequency detection unit for detecting a time period during which occurrence frequency of access to the storage unit from the second data processing section is low, and notifying the access request controller of the time period, and
the access request controller suppresses issuance of access requests except in the time period and promotes issuance of access requests in the time period on the basis of the notification from the access frequency detection unit.

16. The information processing apparatus as defined in claim 10 wherein
the first data processing section comprises:
an error correction means for reading data written in the storage unit and writing error-corrected data obtained by error-correcting the read data into the storage unit; and
a reading means for reading data which is confirmed to have no error by the error detection means, from the storage unit, and outputting the read data to the second data processing section, and
the second data processing section or the access arbitration unit comprises an access frequency detection unit for detecting a start and an end of a time period during which occurrence frequency of access to the storage unit from the second data processing section is low, and notifying the access request controller of the start and the end, and
the first data processing section operates the error correction means and the reading means when the start of the time period is detected by the access frequency detection unit, and the first data processing section delays or stops the operations of the error correction means and the reading means when the end of the time period is detected.

17. The information processing apparatus as defined in claim 11, wherein
the first data processing section comprises:
a demodulating and writing means for demodulating data recorded in a storage medium which can be accessed by the first data processing section and writing the demodulated data into the storage unit;
an error correction means for reading data written in the storage unit and writing error-corrected data obtained by error-correcting the read data into the storage unit;
an error detection means for reading the data which have been error-corrected from the storage unit and checking the data for error; and
a reading means for reading data which is confirmed to have no error by the error detection means, from the storage unit, and outputting the read data to the second data processing section, and
when an access request from the first data processing section is generated by the demodulating and writing means, the arbitration unit sets a priority of an access request to be issued to the access arbitration unit higher than a priority of access requests from the second data processing section, and
when an access request of the first data processing section is generated by any of the error correction means, the error detection means, and the reading means, the arbitration unit sets a priority of an access request to be issued to the access arbitration unit lower than a priority of access requests from the second data processing section.

18. The information processing apparatus as defined in claim 12, wherein
the first data processing section comprises:
a demodulating and writing means for demodulating data recorded in a storage medium which can be accessed by the first data processing section and writing the demodulated data into the storage unit;
an error correction means for reading data written in the storage unit and writing error-corrected data obtained by error-correcting the read data into the storage unit;
an error detection means for reading the data which have been error-corrected from the storage unit and checking the data for error; and
a reading means for reading data which is confirmed to have no error by the error detection means, from the storage unit, and outputting the read data to the second data processing section, and
when an access request from the first data processing section is generated by the demodulating and writing means, the arbitration unit sets a priority of an access request to be issued to the access arbitration unit higher than a priority of access requests from the second data processing section, and
when an access request of the first data processing section is generated by any of the error correction means, the error detection means, and the reading means, the arbitration unit sets a priority of an access request to be issued to the access arbitration unit lower than a priority of access requests from the second data processing section.

19. The information processing apparatus as defined in claim 13, wherein
the first data processing section comprises:
a demodulating and writing means for demodulating data recorded in a storage medium which can be accessed by the first data processing section and writing the demodulated data into the storage unit;
an error correction means for reading data written in the storage unit and writing error-corrected data obtained by error-correcting the read data into the storage unit;
an error detection means for reading the data which have been error-corrected from the storage unit and checking the data for error; and
a reading means for reading data which is confirmed to have no error by the error detection means, from the storage unit, and outputting the read data to the second data processing section, and
when an access request from the first data processing section is generated by the demodulating and writing means, the arbitration unit sets a priority of an access request to be issued to the access arbitration unit higher than a priority of access requests from the second data processing section, and
when an access request of the first data processing section is generated by any of the error correction means, the error detection means, and the reading means, the arbitration unit sets a priority of an access request to be issued to the access arbitration unit lower than a priority of access requests from the second data processing section.
